(19) United States
(12) Patent Application Publication
(10) Pub. No.: US 2003/0121675 A1
(43) Pub. Date: Jul. 3, 2003

(54) Operable latch

(76) Inventor: Newton Roy Gingerich, Baden (CA)

Correspondence Address: Anthony ASQUITH, 173 Westvale Drive, Waterloo, ON, N2T 1B7, CA

(21) Appl. No.: 10/318,394

(22) Filed: Dec. 13, 2002

(30) Foreign Application Priority Data
Dec. 13, 2001 (GB) 0129814.0

(51) Int. Cl. A01B 51/00

(52) U.S. Cl. 172/274; 172/272; 280/186

(57) ABSTRACT

The self-engaging, solenoid-releasable with manual override, latch is designed for use in a variety of applications. As such, the latch accepts the striker peg of the load when misaligned, and the latch accommodates bouncing, sideways laoding, etc of the load, without springing open.

This invention relates to a development of the technology shown in patent publication U.S. Pat. No. 5,738,176 (Gingerich, April 1998).

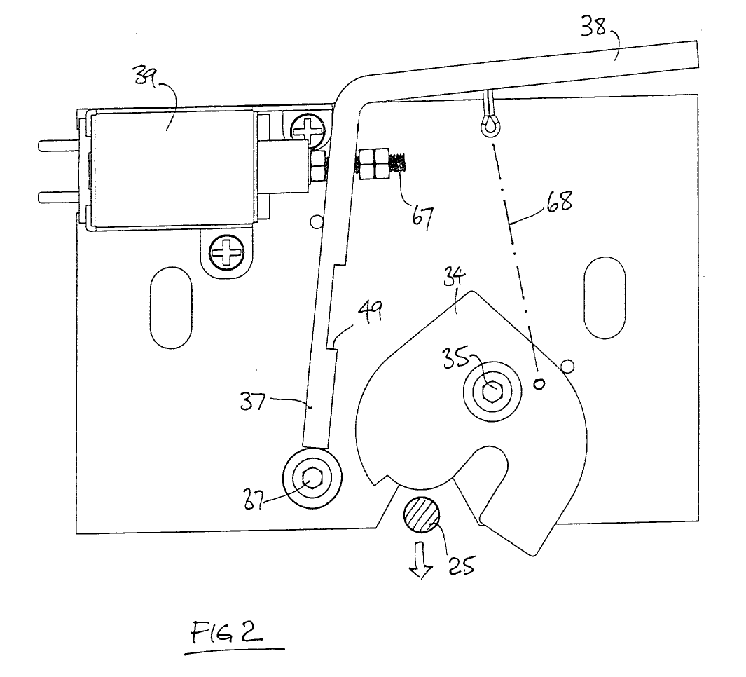

FIG. 2 of that patent shows a latch mechanism, for hitching an accessory to a tractor. The mechanism is automatically self-latching, in that when the mechanism is lowered onto a latch pin or striker-peg of the accessory, the peg becomes hooked into the mechanism. When the mechanism is then raised, the latch peg is retained. The latch mechanism is operable to release the accessory from the tractor by means of a solenoid, and a driver-operated switch in the tractor.

The present invention provides an improved latch mechanism for use in that application, and in applications requiring a similar kind of latch function.

### THE INVENTION IN RELATION TO THE PRIOR ART

Electric-release self-latching mechanisms are well-known. But the general point may be noted that latch designs tend to be specialised to the particular applications. That is to say, the particular latch product caters only for the manner of loading peculiar to the application. Also, generally, the particular latch product is structured so as to take advantage of the strength and rigidity of the structure to which the latch is to be attached.

So, generally, when a given latch structure is used in an application other than that for which it was particularly designed, the latch proves inadequate in some way, whereby trying to adapt an existing specialised latch for general use proves impossible. Especially if the latch has to support heavy forces, side-loading, violent bouncing and shaking, etc, the latch may spring open, or give way, and that is not acceptable.

It is an aim of the present invention to provide a latch design that is capable of supporting heavy and abusive forces within its own structure, without the need for extra rigidity to be provided by the structure to which the latch is attached.

It is also an aim to provide a latch which caters for very many types of misalignments and abusive shaking and bouncing of the load, without ill-effects, and especially without the latch tending to spring open. Thus it is an aim of the invention to provide a latch structure that is suitable to be used in many different applications, and which can be expected to function effectively and safely, without the need for testing programs and modifications to the design in each new application.

The invention also aims to provide a latch that combines electric-release and manual-release, and is easy to manufacture and assemble, and also which is easy to maintain, and the components are easy to service and replace.

### DETAILED DESCRIPTION OF PREFERRED EMBODIMENTS

By way of further explanation of the invention, exemplary embodiments of the invention will now be described with reference to the accompanying drawings, in which:

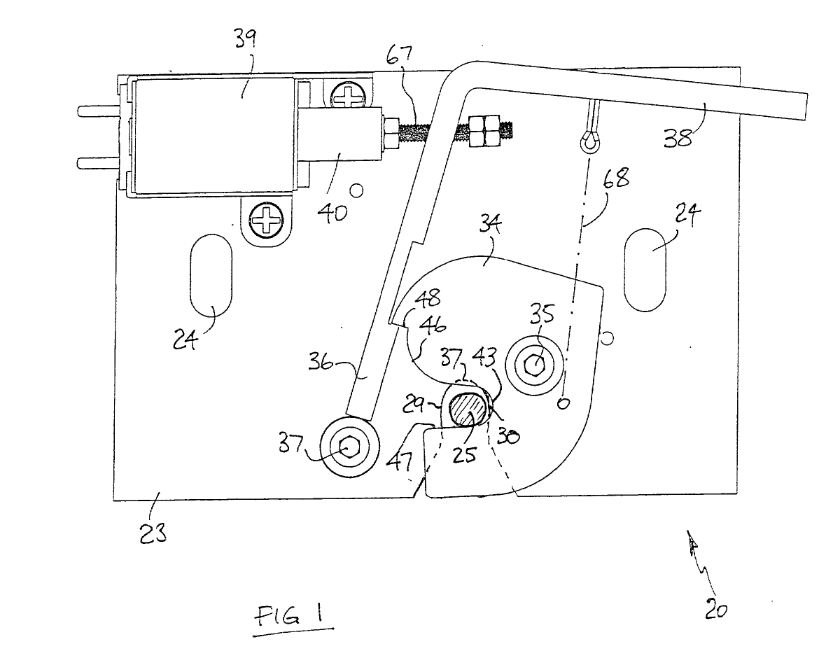

FIG. 1 is an elevation of a latch mechanism which embodies the invention, the latch being shown in an engaged condition.

FIG. 2 is the same elevation as FIG. 1, but shows the latch in a just-disengaged condition.

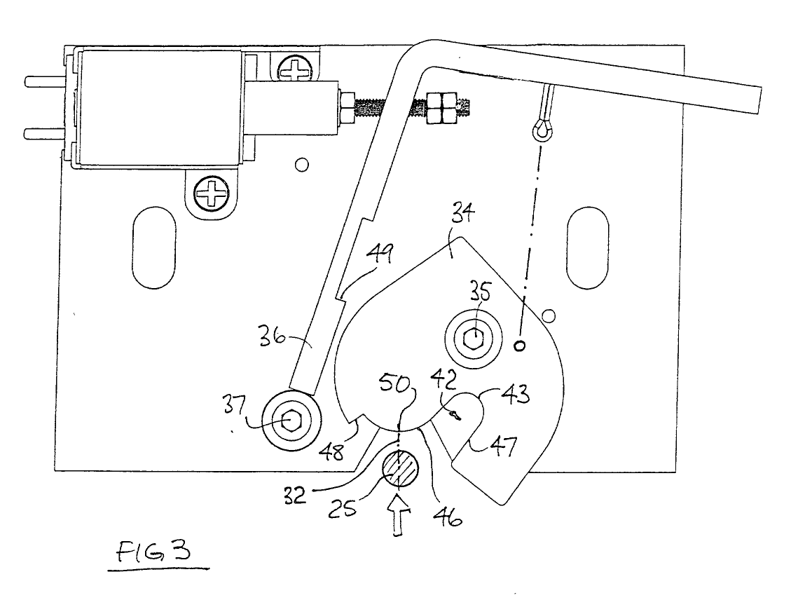

FIG. 3 is the same elevation as FIG. 1, but shows the latch in a disengaged condition, and ready for re-latching.

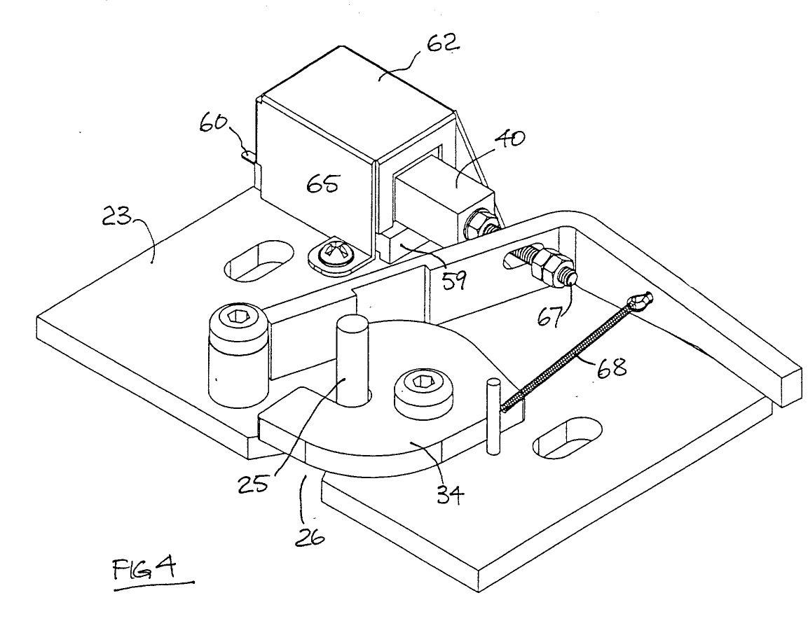

FIG. 4 is a pictorial view of the latch mechanism of FIG. 1.

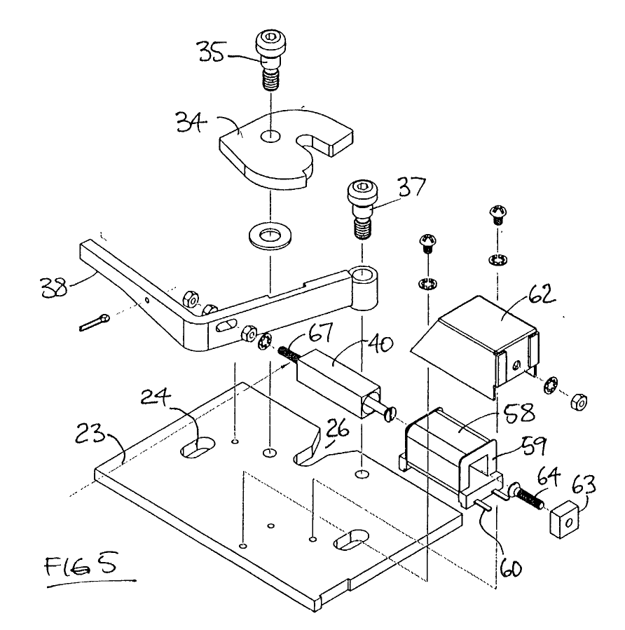

FIG. 5 is the same view as FIG. 4, but the components are exploded.

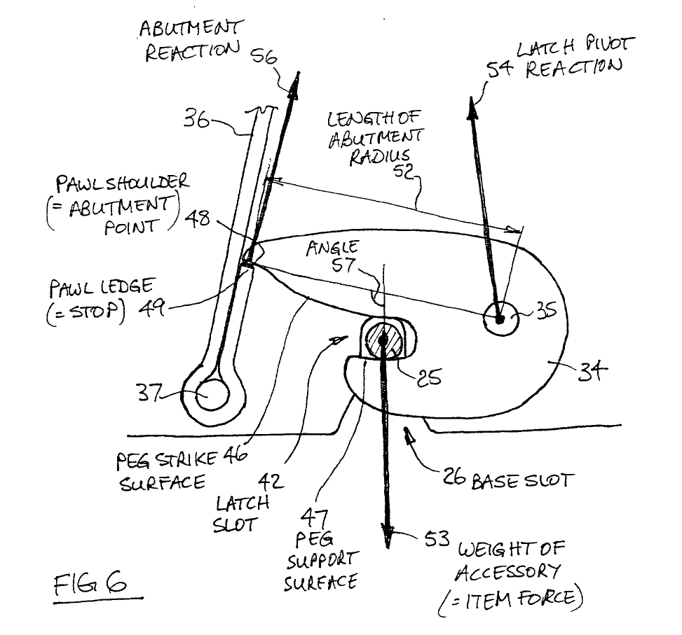

FIG. 6 is a close-up of a latch-lever and associated components of a similar mechanism.

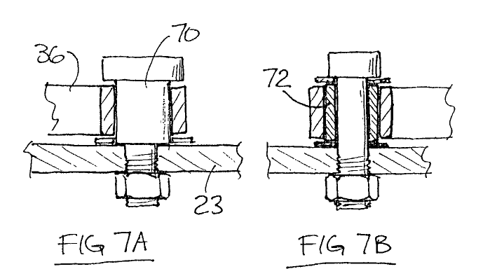

FIGS. 7a,7b are cross-sections illustrating other pivot-pin constructions.

The apparatuses shown in the accompanying drawings and described below are examples which embody the invention. It should be noted that the scope of the invention is defined by the accompanying claims, and not necessarily by specific features of exemplary embodiments.

The latch mechanism 20 shown in FIGS. 1-5 includes a base-plate 23, having fastening-holes 24, by which the base-plate 23 can be fixed to an attachment-body. The function of the latch 20 is to enable an item to be attached to the attachment-body. As may be understood from U.S. Pat. No. 5,738,176, the attachment-body might be, for example, a small electric tractor, and the item to be attached might be a tractor accessory—for example a lawn-mower accessory. The accessory includes a striker-peg 25, which is the component that actually engages into the latch 20. Several accessories can be provided for the tractor, fitted with respective striker-pegs.

Again as may be understood from U.S. Pat. No. 5,738,176, the operation of latching the accessory to the tractor makes use of an operable arm, which carries the latch 20. The accessory rests on the ground, and the tractor, with the arm raised, is manoeuvred until the latch lies poised over the striker-peg 25. The arm is arranged to be operated to move through an arc, so the latch 20 moves predominantly vertically downwards, onto the striker-peg 25. The arm is then lowered, whereby the striker-peg enters the latch 20, until the latch snaps closed onto the striker-peg.

Once the tractor has been correctly manoeuvred over the accessory, the action of lowering the movable arm down onto the accessory is all that is needed to snag the accessory to the tractor. Raising the arm is then effective to raise the accessory off the ground, for moving the accessory, and for lowering the accessory down into contact with the ground, where the accessory can perform its function of grass-cutting, snow-blowing, etc. Thus, the tractor driver can carry out the operation of driving up to an accessory, latching the accessory to the tractor, raising the accessory, driving off, and then lowering the accessory to working height, all without leaving the seat.

Often, in the general case where an item is secured in the latch 20, provision must be made to prevent the item from swinging and rotating with respect to the latch. In other cases, and especially in the case of tractor accessories, the designer may actually require the accessory to swing about, say, the pitch axis of the accessory, in order for the accessory to follow the contours of the land. Indeed, sometimes, the accessory is required to swing universally, i.e to swing about both the pitch and roll axes.

This requirement for the latch to permit the accessory to swing about two axes can place great demands on the latch. The designer should ensure that the latch will not accidentally release the item, under any circumstances. This requirement for the latch to remain latched is an especially demanding one when the accessory can swing with respect to the latch, and especially when the accessory can swing in a universal mode, i.e about two axes.

The requirement is made even more demanding when the accessory is heavy, and when the terrain is such that the accessory, in addition to swinging, is also bouncing and rebounding, and is undergoing many different, and abusive, combinations of misalignments and side-loadings. The scope of the invention is not limited to the item hanging vertically from the latch, nor to cases where the item can swing about two axes, nor to cases where the item is heavy and is subject to violent bouncing; however, a latch that remains secure in those cases is likely to remain secure in all cases.

The base-plate 23 includes a base-slot 26. The base-slot has a closed upper-end 27, and an open mouth at its lower end. The base-slot 26 has sides 29,30, which define a peg-guide-path 32, between the sides, along which the striker-peg 25 is guided, upon entering the base-slot.

Mounted on the base-plate 23 is a latch-lever 34. The latch-lever pivots about a latch-pivot-pin 35. Also mounted on the base-plate is a pawl-lever 36. The pawl-lever pivots about a pawl-pivot-pin 37. An extension of the pawl-lever 36 is provided with a handle 38.

Also mounted on the base-plate is a solenoid unit 39, having a plunger 40.

The latch-lever 34 includes a latch-slot 42. The latch-slot is closed at one end 43, and has an open mouth at its other end. The latch-slot 42 has a peg-strike-surface 46 and a peg-support-surface 47. These sides of the latch-slot receive the striker-peg 25 therebetween;

FIG. 2 shows the latch in its disengaged position, the striker-peg having just been released from the latch. FIG. 3 shows the latch again in its disengaged condition, in which the latch-lever 34 is turned anti-clockwise about the latch-pivot 35. In this position, the mouth of the latch-slot 42 coincides with the mouth of the base-slot 26. Thus, when the striker-peg 25 enters the base-slot 26, it also enters the latch-slot 42.

The striker-peg 25 travels upwards relative to the base-slot 26, along the peg-guide-path 32. In doing so, the striker-peg contacts the peg-striker-surface 46. This contact causes the latch-lever 34 to rotate clockwise about the latch-pivot 35. The layout of the latch-slot 42 means that the striker-peg also travels into the latch-slot. Further upwards motion of the striker-peg into the base-slot 26 is accompanied by further clockwise rotation of the latch-lever, until a pawl-shoulder 48 on the latch-lever 34 clicks or snaps over a pawl-ledge 49 on the pawl-lever 36.

The latch-lever is now in its engaged position (FIG. 1) and the latch is in its engaged condition. The force driving the striker-peg upwards into contact with the peg-strike side 46 of the latch-slot 42 may now be taken away, whereupon the striker-peg 25 settles downwards into contact with the peg-support side 47.

At the engaged position of the latch-lever, the striker-peg is confined to left and right by the two sides 29,30 of the base-slot, is confined above by the closed end 27 of the base-slot, and is confined below by the peg-support-surface 47 of the latch-lever.

The peg-support-surface 47 of the latch-slot 42 preferably should not form an acute angle with either of the sides 29,30 of the base-slot 26. If such an acute angle were formed, the striker-peg might, under some conditions of violent rebound, become wedged (momentarily) into the angle, and might tend to pry the surfaces apart. Of course, the latch designer will see to it that the components of the latch are adequate for supporting the (shock) forces applied to the surfaces, during bouncing, and will apply a suitable safety factor. But the danger is that if the surfaces that locate the peg were angled so that the striker-peg might tend to pry them apart, the force on the surfaces would thereby be multiplied. One of the prime aims of the designer is for security against accidental release, so it is better for the surfaces that support the striker-peg to be perpendicular to each other. Thus, preferably, the peg-support-surface 47 should be horizontal, and the sides 29,30 of the base-slot should be vertical. In fact, the peg-support-surface 47 may be provided with a hollow or depression, so arranged that if the striker-peg should be displaced to left or right of the base-slot, the depression provides a slight bias, to restore the peg to the centre of the base-slot.

It is not only when a load swings from side to side through a large angle, that disruptive forces can be applied to the latch. For example, one side of a hanging load might touch the ground, whereby the striker-peg 25 would be knocked sideways—impacting, perhaps violently, against the side of the base-slot.

As shown in FIG. 3, when lifting the latch-lever 34, the striker-peg 25 contacts the peg-strike-surface 46 at a peg-touch-point 50. As the latch-lever rotates, the peg-touch-point 50 changes, i.e the new peg-touch-point appears at a different location along the peg-strike-surface 46. For smooth operation of the latch to the engaged position, the designer should arrange that the cam configuration of the peg-strike-surface is such that, at each position of the peg-touch-point 50, the peg-strike-surface at that point is horizontal, i.e is perpendicular to the peg-guide-path 32. This helps ensure that the striker-peg remains in the centre of the base-slot, i.e does not rub against the sides 29,30 of the bases-lot, during latching.

Generally, in the invention, at the latch-engaged condition, the latch-lever is prevented from rotating to its disengaged position by the engagement of the abutment-point on the latch-lever with the stop on the strut. In the embodiment of FIGS. 1-5, the latch-lever 34 is held against rotation by the engagement of the pawl-shoulder 48 on the latch-lever against the pawl-ledge 49 on the pawl-lever 36. The generality is that the latch moves to its disengaged condition when the strut collapses; in FIG. 2, the strut collapsed when the pawl-lever 36 moved to the left. The pawl-lever 36 forms a strut in that the loads in the pawl-lever arising from contact with the latch-lever pass down the pawl-lever to the pawl-pivot pin 37, and thence to the base-plate 23.

(The term “strut” sometimes is construed narrowly, in the sense of a rod or bar that is a component of a framework; in the context of the invention, the term strut should be construed more broadly, as meaning any structure that does not collapse under a load force.)

In the engaged condition of the latch, as shown in FIG. 1, and again in FIG. 6, it will be noted that the weight of the item attached to the striker-peg 25 is supported approximately halfway between the latch-pivot pin 35 and the pawl-ledge 49. The distance from the latch-pivot to the abutment stop is the abutment-radius 52, and the abutment-radius is approximately horizontal. That is to say, the abutment-radius 52 is more or less perpendicular to the (vertical) line 53 of the item-force acting through the striker-peg 25, on the latch-lever 34. This arrangement, where the abutment-radius 52 is perpendicular to the line 53 of the item-force, and the line of the item force lies midway between the latch-pivot 35 and the pawl-ledge 49, is a preferred feature of the invention.

It is not essential that the item-force-line 53 lies exactly halfway between the latch-pivot 35 and the pawl-ledge 49. The important aspect is that the item-force-line falls between the latch-pivot and the pawl-ledge. Then, both the latch-pivot reaction force 54 and the abutment reaction force 56 are smaller in magnitude than the weight of the accessory hanging from the striker-peg. If the item-force-line 53 were to fall beyond one of those points 35,49, i.e outside the abutment-radius 52, one of those reaction forces would necessarily be larger than the weight of the accessory.

It is not essential, either, that the abutment-radius 52 be exactly horizontal, i.e exactly perpendicular to the item-force-line 53. If the abutment-radius were angled more than about say twenty degrees to the perpendicular to the item-force-line (angle 57 in FIG. 6), then again the latch-pivot reaction force 54 and the abutment reaction force 56 would, in aggregate, be larger than the weight of the accessory. But the arrangement, as shown, where the abutment-radius 52 is more or less perpendicular to the line 53 of the item-force, and the line of the item-force lies between the latch-pivot 35 and the pawl-ledge 49, means that the reaction forces are at a minimum, i.e the aggregate of the reaction forces is not greater than the weight of the accessory.

The latch must of course be designed to support the loads imposed on it, including the shock and abuse load—but with the depicted arrangement, the latch need not be designed to support a multiplication of those loads. Where the item is a lawnmower accessory, for example, suppose one end of the lawnmower housing should encounter an obstruction, whereby the angle of the lawnmower suddenly changes; now, there is a large momentary side force acting between the striker-peg and the side of the base-slot. A moment later, there may be a side force on the other side of the base-slot. After that, the lawnmower may be bounced bodily clear of the ground, and then rebound. The latch must stand up to these actions, not only of course without breaking, but without the latch springing open. The benefit of the arrangement where the hanging weight of the accessory is divided and distributed between the latch-pivot and the pawl-ledge, and the abutment radius is more or less horizontal, is that it can hardly be envisaged that forces could multiply unexpectedly and accidentally, or could act in unexpected directions, which might cause the latch to spring open. In the depicted design, forces substantially cannot be unexpectedly large.

By spacing the latch-pivot 35 well away from the pawl/lever engagement point 49, the weight from the load is always distributed between the two. The further they are apart, on a horizontal line, the more each one takes its own loads, and other is not affected, even if the load should be bouncing and swinging, or otherwise be misaligned. In the invention, preferably, as mentioned, the abutment-radius 52 should be within twenty degrees of horizontal; but also, where the striker-peg 25 is e.g one cm diameter, the abutment radius should be more than say two cm. When this is so, again it can hardly be imagined that an abusive condition could arise in which the forces between the striker-peg and the latch could accidentally and unexpectedly be high enough to spring the latch open.

The solenoid unit 39, when operated, exerts a force on the plunger 40 that pulls the pawl-lever 36 to the left, thereby disengaging the pawl-shoulder 48 from the pawl-ledge 49, and collapsing the strut. It is preferred to have a lever ratio such that the force at the pawl-shoulder is higher than the force exerted by the solenoid, so the solenoid should lie further out on the pawl-lever than the pawl-shoulder, with respect to the pawl-pivot pin 37.

Similarly, for ease of manual disengagement of the latch, the handle 38 should be at a larger radius than the pawl-shoulder, and preferable at a larger radius than the solenoid.

The structure of the solenoid unit 39 will now be described. The coil-unit 58 is a staple product, comprising a square form-tube 59 of plastic around which the coil is formed. The coil leads 60 are embedded in the plastic. A coil-cover 62 is made of folded sheet steel, and encloses the coil-unit 58, except that the coil-cover is open at the bottom, whereby the coil-unit can simply be dropped into the coil-cover. A plug-nut 63 resides inside the hollow coil tube, and a bolt 64 therein secures the coil-cover to the coil-unit. The coil-cover is then bolted to the base-plate 23.

Thus the solenoid unit 39 is easy to manufacture and assemble, and is securely fixed mechanically to the base-plate. The coil-cover, and the base-plate to which it is bolted, complete the magnetic flux path around and underneath the coil. The front of the coil-cover is shaped and folded so as to leave front margins 65 around the plunger, and the metal of the front margins should be as close as possible to the metal of the plunger, without actually touching.

Preferably, in line with the aim of the invention to provide a latch that can be used in many applications, the solenoid coil should be wound, not for a particular voltage, but to provide effective pull force when supplied with a range of voltages. Thus, the coil preferably should be set to operate over a range of say 12-48 volts DC, or AC.

A screwed rod 67 is attached to the plunger 40, whereby the travel of the plunger can be adjusted to provide a trouble-free pawl release operation.

A spring 68 serves to bias the pawl-lever 36 to its support position, and to bias the latch-lever 34 to its disengaged position.

The base-plate 23 is a single, thick, flat, steel plate. Preferably, the plate should be at least five mm thick for use of the latch on a small tractor, to pick up such accessories as lawnmowers etc, having a striker peg of ten mm diameter. The thickness provides not only basic strength and rigidity, but also provides bearing width, whereby the load between the striker-peg and the sides of the base-slot is spread over a large area, and so does not tend to cut a groove in the peg. The latch-lever 34 preferably is made of the same stock as the base-plate 23.

It is known for latches (and other moving-lever mechanisms) to be mounted, not from a single thick base-plate, but to be sandwiched between a pair of thinner plates. This construction, though not ruled out, is less preferred in the invention, in that the presence of two plates would make it much more difficult to service the unit.

The thick base-plate also means that the pivot pins 35,37 can be cantilevered up out of the base-plate 23. Thus, the pins can be easily replaced, often without unfastening the base-plate from the tractor.

As shown in FIG. 7a, the pivot pin may be formed from a shoulder-bolt 70, or (FIG. 7b) may be formed from an ordinary bolt and a tubular spacer 72, which may be of a bearing material. In each case, lock-nuts or the like should be provided to ensure the pin cannot work loose with respect to the base-plate.

The latch structure as described herein is intended for automatic engagement of a tractor accessory to the vertically-movable arm carried on the tractor. It is intended that automatic engagement will proceed even when the striker peg is only loosely aligned with the mouth of the base-slot, whether the peg is misaligned as to its pitch, roll, or yaw orientation, or as to its front/back or left/right position. Also, the described latch is intended to cater for misalignments between the tractor and the accessory being carried, as might tend to arise during operation. Thus, the described latch should be distinguished functionally from latches (for example vehicle trunk-latches) in which the components are fully aligned before engagement starts, and never move in any mode thereafter, during engagement.

1. A latch, for securing an item to an attachment-body, having facility for releasing the item both electrically and manually, wherein:
[02] the item includes a striker-peg;
[03] the latch includes a base-plate, which is solidly fixable to a complementary attachment-location provided on the attachment-body;
[04] the latch includes a latch-lever, which is rotatable about a lever-pivot, on the base-plate, between a peg-engaged position and a peg-disengaged position;
[05] the latch includes a collapsible strut, which is operable between a support condition and a collapsed condition;
[06] the latch includes an operable electric-releaser, and an operable manual-releaser;
[07] the electric-releaser, when operated electrically, moves the collapsible strut from its support condition to its collapsed condition;
[08] the manual-releaser, when operated manually, moves the collapsible strut from its support condition to its collapsed condition;
[09] the latch is self-securing, in that entry of the striker-peg into the latch is effective to move the latch-lever from its peg-disengaged position to its peg-engaged position, and is effective also to move the collapsible strut from its collapsed condition to its support condition;
[10] the collapsible strut, when in its support condition, and when the latch-lever is in its peg-engaged position, provides a stop against which rests an abutment-point on the latch-lever, and the stop on the strut exerts an abutment-reaction-force against the abutment-point on the latch-lever, which prevents the latch-lever from moving to its disengaged position;
[11] in the collapsed condition of the collapsible strut, the stop on the strut lies clear of the abutment-point on the latch-lever;
[12] the structure of the latch is such that, when the item is latched therein, the item exerts on the latch-lever an item-force, which acts along an item-force-line;
[13] the structure of the latch is such that the item-force-line lies at such position and orientation in the latch as to urge the latch-lever to move from its peg-engaged position to its peg-disengaged position;
[14] the abutment-point on the latch-lever, in relation to the latch-pivot, defines an abutment-radius of the latch-lever, and the abutment-radius is either perpendicular to, or lies within a small angle of perpendicular to, the item-force-line;
[15] the structural arrangement of the latch is such that the item-force-line passes through the abutment-radius between the abutment and the latch-pivot, whereby:
the item-force produces reactions at both the abutment and the latch-pivot, comprising respectively an abutment-reaction and a latch-pivot-reaction;
the abutment-reaction and the pivot-reaction are in aggregate equal to the item-force;
and the abutment-reaction and the latch-pivot-reaction are both smaller than the item-force.

2. Latch of claim 1, wherein:
[02] the latch-lever is formed with an open-mouthed closed-ended latch-slot;
[03] one side of the latch-slot is termed the peg-strike-surface, and the other side is termed the peg-support-surface;
[04] the sides of the latch-slot are dimensioned to receive the striker-peg therebetween;
[05] the base-plate is formed with an open-mouthed closed-ended base-slot;
[06] the sides of the base-slot are dimensioned to receive the striker-peg therebetween, and to define a peg-guide-path for the striker-peg;
[07] the base-slot is orientated, on the base-plate, such that, upon the attachment-body being presented to the latch, for latching thereto, the striker peg enters the mouth of the base-slot, and travels lengthwise along the base-slot;
[08] in the disengaged condition of the latch, the latch-lever lies in a disengaged-position, in which the mouth of the latch-slot lies aligned with the mouth of the base-slot, being aligned to the extent that the strike-peg, upon entering into the mouth of the base-slot, enters also into the mouth of the latch-slot;
[09] the base-slot and the latch-slot are aligned in relation to the latch-pivot such that, upon the striker-peg entering into the mouths of, and travelling along, the latch-slot and the base-slot, the striker-peg engages the latch-slot at a peg-touch-point on the peg-strike-surface, and thereby applies a force to the latch-lever, at that point, which causes the latch-lever to rotate about the latch-pivot;
[10] the engaged condition of the latch is a condition reached by the latch after the striker-peg has travelled along the base-slot, and the latch-lever has rotated to an engaged-position.

3. Latch of claim 2, wherein the base-plate is vertical, and the line of engagement of the striker-peg in the base-slot is vertical.

4. Latch of claim 3, wherein, during engagement of the latch, the line of force of the weight of the item, through the peg-touch-point, is in line with peg-guide-path, whereby the striker-peg either does not touch the sides of the base-slot, or, if it touches, the striker-peg does not exert a significant force on the side of the base-slot.

5. Latch of claim 1, wherein:
[02] the collapsible-strut of the latch includes a pawl-lever, a pawl-ledge on the pawl-lever which comprises the stop, and a pawl-shoulder on the latch-lever which comprises the abutment-point;
[03] the pawl-lever is rotatable about a pawl-pivot, on the base-plate, between the collapsed condition and the support condition of the strut.

6. Latch of claim 1, wherein:
[02] the item has substantial weight, and the item hangs downwards from the striker-peg;
[03] the open mouth of the base-slot is in a bottom edge of the base-plate;
[04] the sides of the base-slot define a peg-guide-path, being the path along which the striker peg travels during engagement of the latch;
[05] the peg-guide-path is vertical;
[06] when the latch-lever is in its engaged position, and the striker-peg is resting on the peg-support-surface of the latch-lever, the peg-support-surface of the latch-slot faces substantially straight upwards.

7. Latch of claim 2, wherein the peg-support-surface includes a hollow, which is located so as to bias the peg to the centre of the base-slot, clear of the sides of the base-slot.

8. Latch of claim 1, wherein:
[02] the attachment body is a tractor or other vehicle;
[03] the vehicle includes a vertically-movable arm, and the item is an accessory which is designed to operate while suspended from the arm;
[04] the latch is mounted on the moveable arm, and the solenoid is operable by a switch on the tractor;
[05] the accessory carries the strike-peg, which is so arranged that the accessory can hang with its weight supported by the strike-peg, in the latch.

9. Latch of claim 1, wherein:
[02] the latch-pivot includes a latch-pivot-pin, which is mounted cantilever-fashion on the base-plate;
[03] and the pawl-pivot includes a pawl-pivot-pin, which is mounted cantilever-fashion on the base-plate.

10. Latch of claim 1, wherein the peg-strike-surface is convexly curved, and is so shaped that, at every orientation of the latch-lever about the latch pivot, the angle of the surface at the touch-point lies at right angles to the engagement direction

11. Latch of claim 1, wherein the peg-resting surface of the latch-lever has a depression, positioned for centering the striker-peg midway between the sides of the base-slot, in the engaged condition.

12. Latch of claim 1, wherein the base-plate is at least 3/16″ thick, flat steel plate.

13. Latch of claim 1, wherein the latch-lever is at least 3/16″ thick, flat steel plate.

14. Latch of claim 1, wherein:
[02] the solenoid is housed in a sheet steel housing, which is folded to enwrap the solenoid coil;
[03] the steel almost touches the plunger where the plunger emerges from the coil;
[04] at the other end of the coil, a metal plug-nut fills the coil-former, and is fixed to a back flap of housing;
[05] the housing is bolted directly to base-plate, whereby the base-plate completes a flux path underneath the coil.

15. Latch of claim 1, wherein the housing is open at the bottom, whereby the coil can be simply dropped into the hosuing, and, after the plug-nut is fixed to the back of housing, the housing can be fixed to the base-plate.

16. Latch of claim 1, wherein the solenoid plunger is square, and the coil-former is correspondingly square.

17. Latch of claim 1, wherein:
[02] the pawl-shoulder lies at a radius PR of the pawl-lever, with respect to the pawl-pivot;
[03] the solenoid-pull-point lies at a radius SR of the pawl-lever, with respect to the pawl-pivot;
[04] where SR is larger than PR.

18. Latch of claim 1, wherein:
[02] the manual-releaser comprises a handle carried on the pawl-lever, which lies at a radius HR of the pawl-lever, with respect to the pawl-pivot;
[03] where HR is larger than SR.

19. Latch of claim 1, wherein:
[02] the latch includes a latch-lever-biassing spring, which biasses the latch-lever towards its disengaged position;
[03] the latch includes a release-lever-biassing-spring, which biasses the pawl-lever towards its support-position.
